(19) United States
(12) Patent Application Publication
(10) Pub. No.: US 2026/0136274 A1
(43) Pub. Date: May 14, 2026

(54) SYSTEMS AND METHODS FOR PROVIDING HIGH SECURITY QUANTUM-SAFE NETWORK SLICES

(71) Applicant: Verizon Patent and Licensing Inc., Basking Ridge, NJ (US)

(72) Inventors: Vinod Kumar CHOYI, Conshohocken, PA (US); Yousif TARGALI, Sammamish, WA (US); Sudhakar Reddy PATIL, Flower Mound, TX (US)

(73) Assignee: Verizon Patent and Licensing Inc., Basking Ridge, NJ (US)

(21) Appl. No.: 18/924,235

(22) Filed: Oct. 23, 2024

(51) Int. Cl. H04W 48/18; H04W 12/043; H04W 12/69

(52) U.S. Cl. CPC H04W 48/18; H04W 12/043; H04W 12/69

(57) ABSTRACT

A network device may receive, from a user equipment (UE), a secure identifier of the UE and a request for a network slice, and may determine, based on the request and the secure identifier, that the UE is requesting a quantum-safe network slice. The network device may determine that the secure identifier of the UE is not a quantum-safe secure identifier, and may validate whether the UE is a subscriber to the quantum-safe network slice. The network device may receive an indication that the UE is a subscriber to the quantum-safe network slice, and may generate a rejection of the request for the network slice based on determining that the secure identifier of the UE is not a quantum-safe secure identifier. The network device may provide, to the UE, the rejection and an instruction to utilize the quantum-safe secure identifier of the UE instead of the secure identifier.

### BACKGROUND

The telecommunications industry, including mobile network operators (MNOs), has long been grappling with the challenge of providing secure communications for subscribers, especially with the advent of fifth-generation (5G) networks. These networks rely on advanced cryptographic schemes to ensure user authentication, endpoint authentication, and the integrity and confidentiality of data.

### BRIEF DESCRIPTION OF THE DRAWINGS

FIGS. 1A-1D are diagrams of an example associated with providing high security quantum-safe network slices.

FIG. 2 is a diagram of an example environment in which systems and/or methods described herein may be implemented.

FIG. 3 is a diagram of example components of one or more devices of FIG. 2.

FIG. 4 is a flowchart of an example process for providing high security quantum-safe network slices.

### DETAILED DESCRIPTION OF EXAMPLE EMBODIMENTS

The following detailed description of example implementations refers to the accompanying drawings. The same reference numbers in different drawings may identify the same or similar elements.

The rise of quantum computing poses significant threats to cryptographic methods utilized to secure networks. A quantum computer has the potential to compromise asymmetric cryptographic schemes, making current encryption vulnerable to attacks. Such attacks could be carried out by entities with substantial resources, leading to unauthorized decryption of protected traffic and compromise of digital signature schemes. The integrity of encrypted communications and authentication systems, relied upon for secure communication in fifth-generation (5G) networks, could be critically weakened by quantum computing. Thus, current techniques for providing secure communications for network subscribers consume computing resources (e.g., processing resources, memory resources, communication resources, and/or the like), networking resources, and/or other resources associated with failing to provide secure communications for a user equipment (UE) within a network, handling poor user experience and/or theft of data due to failing to provide secure communications for the UE within the network, failing to authenticate the UE with the network, and/or the like.

Some implementations described herein provide high security quantum-safe network slices. For example, a network device (e.g., of a core network) may receive, from a UE, a secure identifier of the UE and a request for a network slice, and may determine, based on the request and the secure identifier, that the UE is requesting a quantum-safe network slice. The network device may determine that the secure identifier of the UE is not a quantum-safe secure identifier, and may validate whether the UE is a subscriber to the quantum-safe network slice. The network device may receive an indication that the UE is a subscriber to the quantum-safe network slice, and may generate a rejection of the request for the network slice based on determining that the secure identifier of the UE is not a quantum-safe secure identifier. The network device may provide, to the UE, the rejection and an instruction to utilize the quantum-safe secure identifier of the UE instead of the secure identifier.

In this way, high security quantum-safe network slices may be provided. For example, a network device may receive a secure identifier that is not quantum-safe from a UE that is a subscriber to a quantum-safe network slice. The network device may prevent the UE from accessing the quantum-safe network slice and may instruct the UE to use a quantum-safe secure identifier. After receiving the quantum-safe secure identifier from the UE, the network device may register the UE with the quantum-safe network slice and assign appropriate network functions to provide a requested service after performing an authentication of the UE using, for example, a 5G authentication and key agreement (5G AKA) protocol. The network device may reduce the risk of unauthorized access, tracking of the UE, and the breadth of potential data breaches, which can be critical for maintaining the integrity and performance of 5G network infrastructure. Thus, the network device may conserve computing resources, networking resources, and/or other resources that would have otherwise been consumed by failing to provide secure communications for a UE within a network, handling poor user experience and/or theft of data due to failing to provide secure communications for the UE within the network, failing to authenticate the UE with the network, and/or the like.

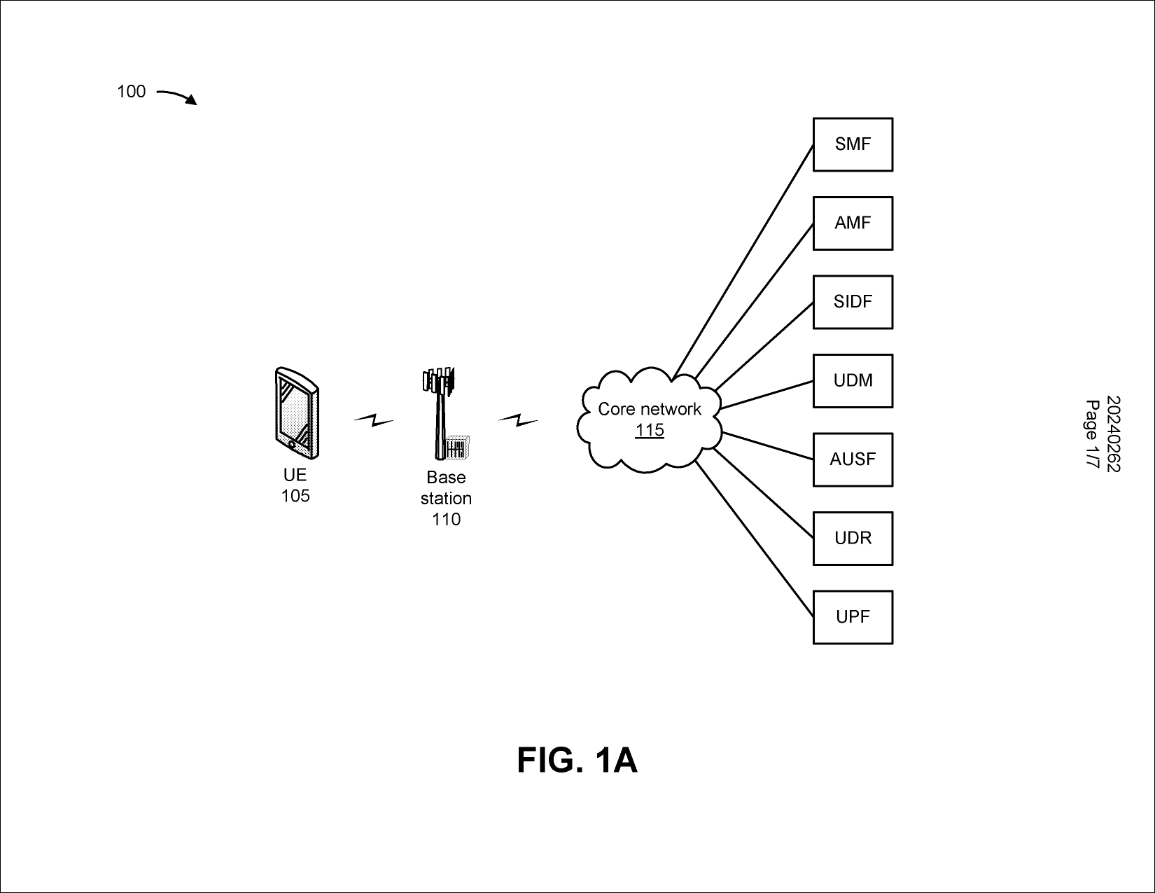

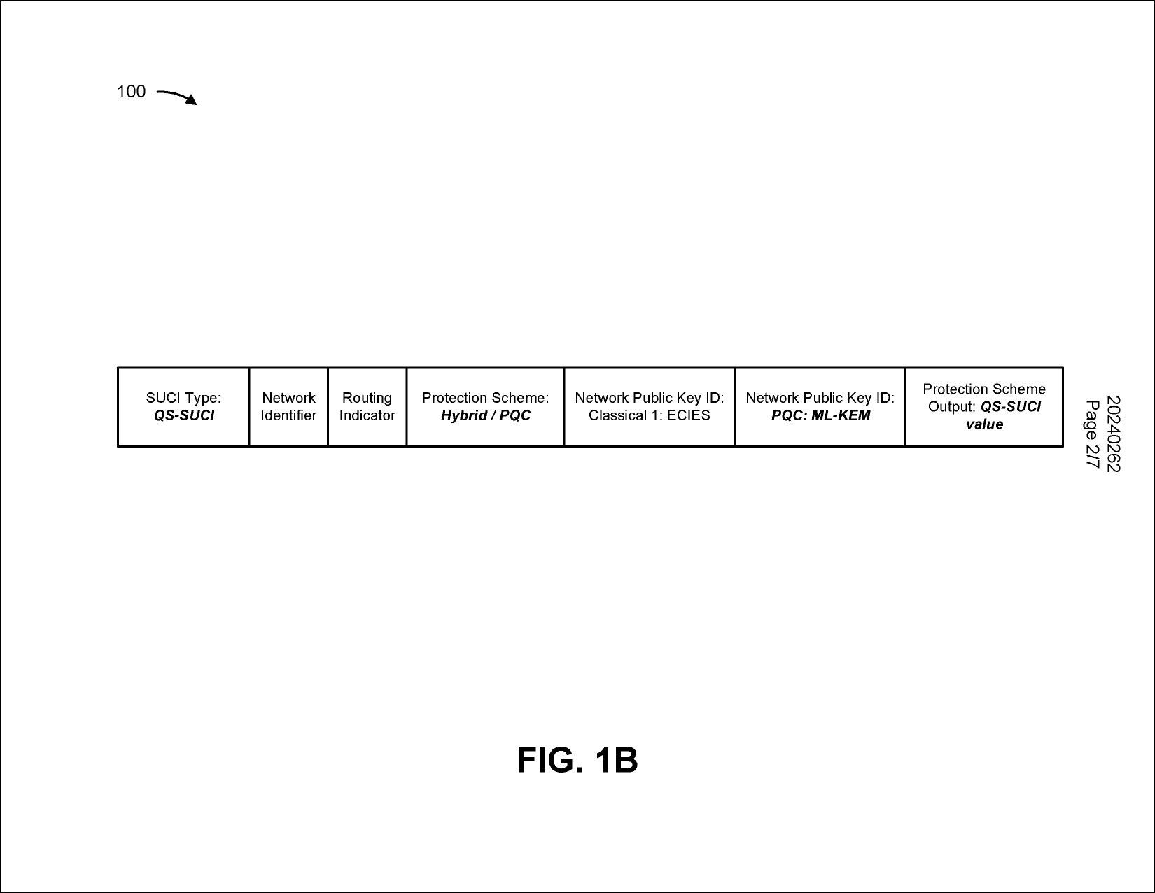

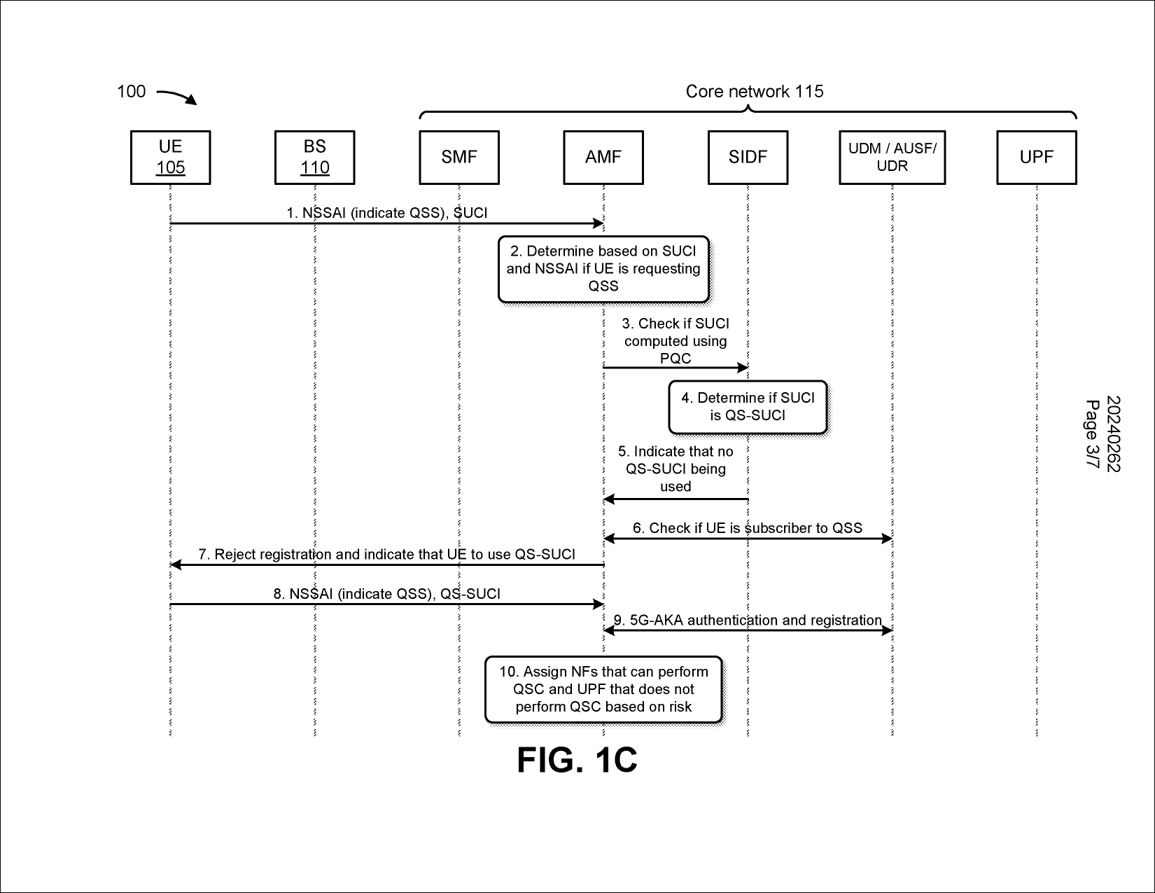

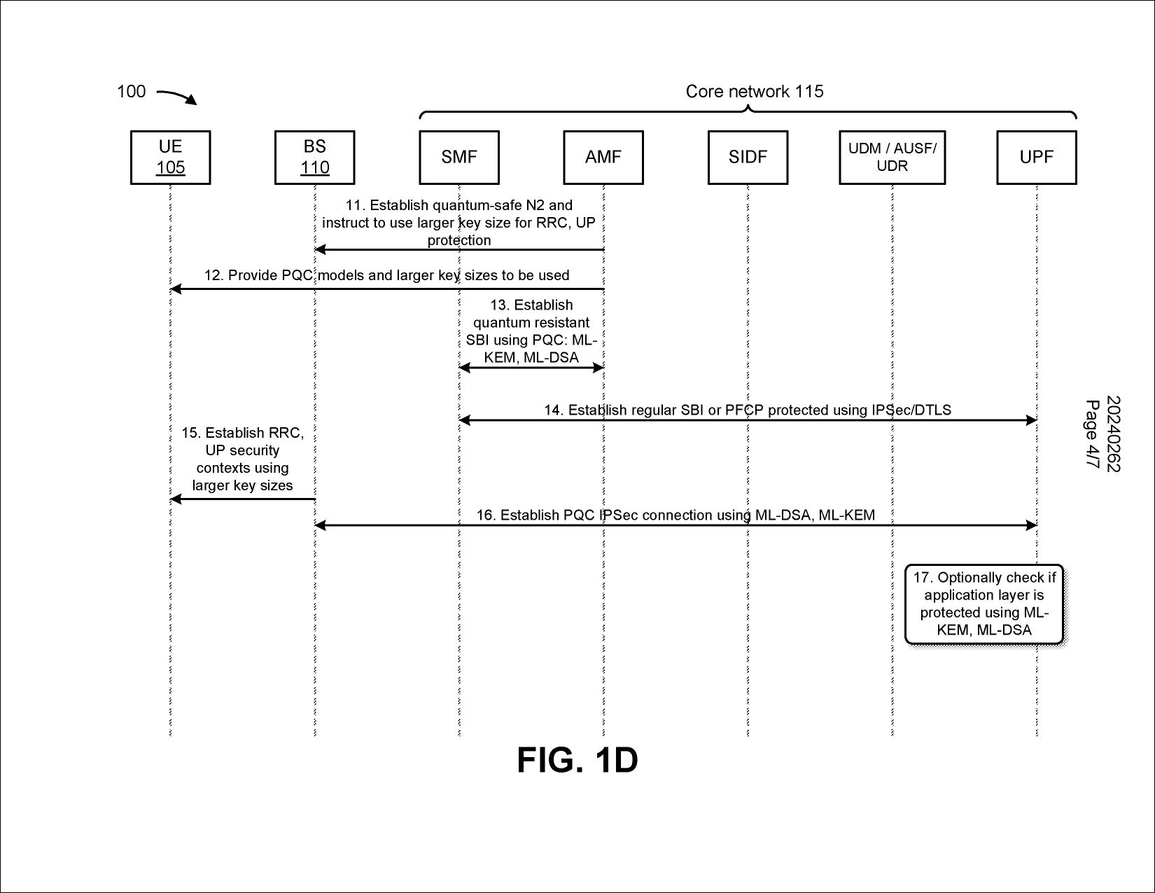

FIGS. 1A-1D are diagrams of an example 100 associated with providing high security quantum-safe network slices. As shown in FIGS. 1A-1D, the example 100 includes a UE 105 associated with a base station 110 and a core network 115 that includes a session management function (SMF), an access and mobility management function (AMF), a subscriber identity de-concealing function (SIDF), a unified data management (UDM) component, an authentication server function (AUSF), a unified data repository (UDR), and a user plane function (UPF). Further details of the UE 105, the base station 110, the core network 115, the SMF, the AMF, the SIDF, the UDM, AUSF, the UDR, and the UPF are provided elsewhere herein.

FIG. 1B depicts example fields of a quantum-safe subscriber concealed identifier (SUCI) (QS-SUCI) for the UE 105. As shown, the QS-SUCI may include an SUCI type field (e.g., QS-SUCI), a network identifier field, a routing indicator field, a protection scheme field (e.g., hybrid / post-quantum cryptography (PQC)), a first network public key identifier (ID) (e.g., classical 1: elliptic curve integrated encryption scheme (ECIES)), a second network public key ID (e.g., PQC: module-lattice-based key-encapsulation mechanism (ML-KEM)), and a protection scheme output (e.g., QS-SUCI value), which is the quantum-safe encrypted SUCI.

In some implementations, the QS-SUCI type in the SUCI type field may distinguish the QS-SUCI from traditional SUCI types. This field may help in quick identification and categorization of the identifier, thereby improving processing efficiency. Additionally, or alternatively, the QS-SUCI may include additional fields for subscriber authentication information. These fields may store data, such as subscriber authentication keys or tokens, enhancing security and verification procedures. Additionally, or alternatively, the QS-SUCI may include other PQC techniques being applied, such as lattice-based cryptography, multivariate polynomial cryptography, code-based cryptography, and/or the like.

In some implementations, the protection scheme field may specifically indicate if the identifier was generated using a post-quantum secure key establishment and encapsulation protocol (e.g., ML-KEM) or using classical encryption reinforced with quantum-resistant measures. For example, a field may indicate whether hash-based signatures or other post-quantum measures are ensuring the enhanced security. Additionally, or alternatively, the first network public key ID field may include a Rivest-Shamir-Adleman (RSA)-based or a discrete-logarithm-based classical key-exchange scheme. RSA or ECC / Diffie-Hellman can provide familiar and well-established mechanisms for initial secure communications.

In some implementations, the second network public key ID field may reference any PQC scheme selected based on an agreed security policy. Potential examples could include the use of hash-based, lattice-based, or even newer forms of PQC, depending on security requirements and policy agreements. Additionally, or alternatively, the protection scheme output field may contain authenticated encryption results produced by combining classical and quantum-safe methodologies. This output field may include results from processes that exhaustively verify the integrity and confidentiality of transmitted data.

In some implementations, the QS-SUCI may include a validation field to verify whether a generated identifier adheres to quantum-safe standards. The validation may be useful in environments with stringent security requirements, ensuring compliance and robustness against attacks. Additionally, or alternatively, the QS-SUCI may include a timestamp field to record a generation time, ensuring a validity of the QS-SUCI within a specific time window. A timestamp can mitigate replay attacks by allowing systems to verify the freshness of the identifier.

In some implementations, the QS-SUCI may include an extended metadata field providing additional context for the secure communication session. The additional context may include session-specific information, such as key lifecycle details, unique session identifiers, or any other relevant metadata assisting in secure communication. Additionally, or alternatively, instead of a protection scheme output field, the QS-SUCI may include an integrity check field to ensure unaltered transmission of authentication data. Techniques such as checksums, hash functions, or digital signatures may be employed to maintain data integrity.

In some implementations, the second network public key ID field may utilize a hash-based signature scheme, rather than ML-KEM, for post-quantum security. Hash-based signatures, known for their quantum resistance, may offer an alternative to lattice-based mechanisms. Additionally, or alternatively, the QS-SUCI may integrate with multiple security layers, including transport layer security (TLS) featuring quantum-safe algorithm support. Such multi-layered security integration can provide comprehensive protection across different communication stages. In some implementations, instead of the protection scheme fields, a single field indicating a negotiated security protocol, encompassing classical and quantum-safe elements, may be utilized. This may streamline the identification and setup processes by reducing the number of fields while still conveying critical security information.

FIGS. 1C and 1D depict an example information flow diagram associated with providing high security quantum-safe network slices. As shown at step 1 of FIG. 1C, the AMF may receive, from the UE 105, network slice selection assistance information (NSSAI) (e.g., indicating that a quantum-safe network slice (QSS) is desired) and a SUCI of the UE 105. For example, the UE 105 may generate the NSSAI indicating that the quantum-safe network slice is desired and may generate the SUCI of the UE 105. The UE 105 may provide the NSSAI and the SUCI to the AMF, and the AMF may receive the NSSAI and the SUCI of the UE 105. The AMF may be configured to accept requests indicating a quantum-safe network slice as a preferred service. The NSSAI may indicate the intent for utilizing the quantum-safe network slice capable of PQC for secure communications. Additionally, or alternatively, the NSSAI may include additional parameters, such as security levels or expected quality of service (QoS) requirements. Additionally, or alternatively, instead of NSSAI, an alternative identifier with similar functionality (e.g., a slice-specific indicator) may be used to indicate that the quantum-safe network slice is desired.

As shown at step 2, the AMF may determine, based on the SUCI and NSSAI, if the UE 105 is requesting a quantum-safe network slice. For example, the AMF may analyze the NSSAI and the SUCI to ascertain specific service requirements of the UE 105, such as a need for enhanced security measures facilitated by the quantum-safe network slice. In some implementations, this determination may include the AMF evaluating additional network context parameters, such as a current network load, to decide if the quantum-safe network slice is feasible. By assessing network capacity, the AMF may better allocate resources while maintaining optimal service levels. Additionally, or alternatively, the AMF may perform an initial check based on pre-stored policies to determine whether the requested slice falls under quantum-safe requirements.

As shown at step 3, based on determining that the UE 105 is requesting a quantum-safe network slice, the AMF may request the SIDF to check if the SUCI is computed using PQC. For example, the AMF may communicate with the SIDF to validate whether the received SUCI adheres to PQC standards, ensuring a robustness of the SUCI against quantum computing threats. In some implementations, the AMF may request validation of the SUCI from another dedicated security function, rather than the SIDF. By involving various security functions, the AMF can incorporate multiple layers of verification. Additionally, or alternatively, the AMF may perform pre-validation checks using local models before querying the SIDF. The preliminary checks can quickly filter out clearly invalid identifiers, optimizing the security validation workflow.

As shown at step 4, based on the request, the SIDF may determine if the SUCI is a QS-SUCI. For example, the SIDF may evaluate the cryptographic attributes of the SUCI to confirm if the SUCI qualifies as a quantum-safe or hybrid identifier. In some implementations, the SIDF may apply additional cryptographic checks or multiple models to ensure that the SUCI adheres to PQC standards. This may include using hash-based or lattice-based cryptographic techniques to reinforce identifier security. Additionally, or alternatively, alternative methods of verification, such as checking specific signatures or cryptographic keys associated with QS-SUCI, may be utilized to determine if the SUCI is a QS-SUCI.

As shown at step 5, the SIDF may determine that the SUCI is not a QS-SUCI, and may indicate, to the AMF, that no QS-SUCI is being used by the UE 105. For example, the SIDF may analyze the SUCI and may determine that the SUCI is not a QS-SUCI based on the analysis. Upon identifying the non-quantum-resistant nature of the SUCI, the SIDF may indicate, to the AMF, that that a QS-SUCI is not being used by the UE 105. In some implementations, the SIDF may provide, to the AMF, additional information, such as potential security risks inherent in the non-QS-SUCI. This detailed feedback may inform the AMF about vulnerabilities and may recommend preventive measures. Additionally, or alternatively, instead of indicating that no QS-SUCI is being used, the SIDF may provide historical data or context about previous submissions from the UE 105. The historical data or context may aid in detecting patterns and improving future request evaluations.

As shown at step 6, the AMF may check if the UE 105 is a subscriber to the quantum-safe network slice (e.g., with the UDM, the AUSF, and the UDR). For example, the AMF may access subscriber information from various network components to verify whether the UE 105 is a subscriber to the quantum-safe network slice. In some implementations, the subscription validation process may also include querying alternative or additional database components, such as a dedicated quantum-slice subscriber registry. Additionally, or alternatively, the AMF verify compliance with specific security policies or recent updates in the subscriber’s profile.

As shown at step 7, the AMF may reject the registration of the UE 105 for the quantum-safe network slice and may indicate that the UE 105 is to use a QS-SUCI instead of the SUCI. For example, after verifying the subscription and determining that the UE 105 is not a subscriber to the quantum-safe network slice, the AMF may formally deny access to the requested quantum-safe slice and may instruct the UE 105 to use a properly formulated quantum-safe identifier for subsequent requests. In some implementations, the AMF may provide a list of steps for the UE 105 to follow to correct future requests, including pointers to configurations required (e.g., including a home network public key) to generate the QS-SUCI. This guidance may help the UE 105 rectify the identifier issue effectively. Additionally, or alternatively, the registration of the UE 105 for the quantum-safe network slice may include troubleshooting tips or a temporary authentication mechanism until the QS-SUCI is available.

As shown at step 8, the AMF may receive, from the UE 105, the NSSAI (e.g., indicating that the quantum-safe network slice is desired) and a QS-SUCI of the UE 105. For example, following the rejection of the NSSAI, the UE 105 may provide, to the AMF, other NSSAI (e.g., indicating another request for the quantum-safe network slice) that includes a corrected QS-SUCI that uses quantum-safe cryptography (e.g. ML-KEM) as well as a quantum safe home network public key that was provided by the AMF. In some implementations, in the subsequent NSSAI, the UE 105 may provide additional metadata to help the AMF quickly validate the QS-SUCI. The metadata may include information for speeding up the validation process. Additionally, or alternatively, the UE 105 may provide a preliminary validation request to ensure that the QS-SUCI meets required standards before full submission.

Upon validating a QS-SUCI by the AMF using the SIDF, and as shown at step 9, the AMF may utilize a 5G-authentication and key agreement (AKA) method to authenticate and register the UE 105 with the quantum-safe network slice. For example, the AMF may conduct a secure authentication process to validate an identity and eligibility of the UE 105, which may facilitate registration of the UE 105 with the desired quantum-safe network slice. In some implementations, the authentication may include additional cryptographic proofs of identity and integrity beyond the standard 5G-AKA method. The additional cryptographic proofs may enhance the overall validation by adding more layers of security. Additionally, or alternatively, the AMF may utilize multiple rounds of authentication at different security levels before final registration. This may ensure that the UE 105 meets all security requirements before being granted access.

As shown at step 10, the AMF may assign network functions (NFs), such as a session management function (SMF), that can perform quantum safe computing (QSC) and may assign a UPF that does not perform QSC (e.g., based on risk). For example, the AMF may evaluate security capabilities of network functions and may assign network functions that can handle quantum-safe communications, ensuring the overall integrity and security of the network slice while balancing operational risks. In some implementations, the AMF may consider dynamic network conditions, such as current traffic patterns, to optimize resource allocation. Alternative approaches may be employed by the AMF and may include assigning virtual network functions (VNFs) specialized in quantum-safe communications, or using dedicated hardware accelerators for PQC tasks. These approaches enable variability in network resource management. Additionally, or alternatively, the AMF may utilize machine learning models to dynamically predict and mitigate potential security risks.

As shown at step 11 of FIG. 1D, the AMF may establish a quantum-safe N2 interface with the base station 110 and may instruct the base station 110 to use a larger key size for radio resource control (RRC) and user plane (UP) protection utilizing symmetric key encryption (e.g., AES-256 or AES-384). For example, the AMF may establish a secure communication interface (e.g., the N2 interface) with the base station 110 to handle data transmission under enhanced security measures, and may instruct the base station 110 to incorporate larger cryptographic keys for added protection against quantum computing-based threats. In some implementations, the N2 interface may rely on established quantum-resistant protocols to ensure that RRC and UP communications are adequately fortified. For example, the base station 110 may be instructed to adopt 256-bit keys or greater for both RRC and UP data, which may reinforce the overall security of the network communications. In some implementations, the AMF may instruct the base station 110 to use larger key sizes, such as 512-bit keys, for RRC and UP protection. This increased key size may significantly enhance the cryptographic strength against quantum computing attacks. Additionally, or alternatively, the AMF may utilize predefined quantum-safe communication protocols to instruct the base station 110 on implementing enhanced encryption standards to mitigate threats. The predefined quantum-safe communication protocols may include specific strategies tailored to counteract known quantum attacks. Additionally, or alternatively, for enhanced security, the AMF may implement dynamically adjustable key sizes for various communication contexts based on a perceived threat level. This adaptive approach may optimize security levels in real-time depending on security requirements and potential vulnerabilities.

As shown at step 12, the AMF may provide, to the UE 105, PQC models and larger key sizes to be used by the UE 105. For example, the AMF may provide, to the UE 105, the necessary cryptographic parameters to ensure that the UE 105 operates under the defined quantum-safe protocols. The inclusion of the PQC models and the larger key sizes may maintain the security integrity of interactions between the UE 105 and network elements. Additionally, the PQC models may include hybrid models that combine classical cryptographic measures with quantum-resistant features. The hybrid models may ensure both backward compatibility and enhanced security, and may include the strengths of both classical and quantum-resistant cryptosystems. Additionally, or alternatively, the AMF may provide specific cryptographic libraries or firmware updates to enable the UE 105 to handle complex encryption and authentication mechanisms under quantum-safe policies. The firmware updates may enable the UE 105 to seamlessly transition to using quantum-resistant protocols without significant hardware modifications. Additionally, or alternatively, the AMF may provide, to the UE 105, adaptive encryption strategies based on real-time network security analysis to ensure that the UE 105 maintains consistent quantum-safe communication standards. This may include continuous monitoring and adjusting of the cryptographic parameters in response to detected threats or changes in network conditions.

As shown at step 13, the AMF may establish a quantum-resistant service based interface (SBI) with the SMF using PQC: ML-KEM and module-lattice-based digital signature standard (ML-DSA). For example, the AMF may set up, with the SMF, a secure communication channel (e.g., the SBI) with advanced cryptographic standards, including ML-KEM for key encapsulation and ML-DSA for digital signatures. This may ensure that data integrity and authentication processes are resistant to potential quantum computing attacks. In some implementations, the AMF may utilize alternative advanced PQC techniques, such as lattice-based cryptographic models, to ensure a robust SBI with the SMF. Lattice-based models provide heightened security against quantum attacks due to their complex mathematical underpinnings. Additionally, or alternatively, the AMF may provide quantum-resistant hardware security modules (HSMs) to enhance the security of key management in establishing the quantum-resistant SBI. The use of quantum-resistant HSMs may ensure that cryptographic keys are generated, stored, and managed in a secure hardware environment, reducing exposure to potential software vulnerabilities.

As shown at step 14, the SMF may establish, with the UPF, a regular SBI or a packet forwarding control protocol (PFCP) protected interface using an Internet protocol security (IPSec) connection or a datagram transport layer security (DTLS) connection. For example, the SMF may utilize IPSec or DTLS to protect signaling and data exchanges with the UPF, ensuring that quantum-safe communication standards are upheld. In some implementations, the SMF may dynamically select an appropriate cryptographic protocol based on real-time network conditions. In some implementations, the SMF may use post-quantum tunneling protocols in combination with IPSec or DTLS for securing interfaces with the UPF. These tunneling protocols may utilize advanced cryptographic techniques to further protect data exchanges against quantum threats. Additionally, or alternatively, the SMF may utilize session-specific encryption keys that change with each session to further protect against quantum-based decryption attempts. Regularly changing encryption keys with each session ensures that even if a key were compromised, it would only affect one session, limiting the potential damage. It may be assumed that either all or a subset of the SBI and non-SBI interfaces are protected using quantum-safe protocols (e.g., TLS 1.3 and/or IKE/IPSec with ML-KEM, or ML-DSA).

As shown at step 15, the base station 110 may establish RRC and UP security contexts with the UE 105 using the larger key sizes. For example, upon receiving the larger cryptographic keys as instructed by the AMF, the base station 110 may synchronize with the UE 105 to create secure transmission channels for both RRC signaling and UP data. The larger key sizes may significantly enhance the robustness of the encryption, providing stronger defense mechanisms against emerging quantum threats. In some implementations, the base station 110 may use variable key sizes, optimized based on the type of data being transmitted, for establishing RRC and UP security contexts with the UE 105. For example, more critical data may utilize larger keys, while less sensitive transmissions may utilize smaller keys to balance security and performance. Additionally, or alternatively, enhanced integrity verification protocols, such as hash-based signatures, may be integrated as additional security layers for RRC and UP data protection. These protocols ensure data integrity by checking that data has not been altered in transit, adding an additional layer of security.

As shown at step 16, the base station 110 may establish a PQC IPSec connection with the UPF using ML-DSA and/or ML-KEM. For example, the communication link between the base station 110 and the UPF may be fortified using quantum-safe cryptographic protocols. Utilizing ML-DSA for authentication and ML-KEM for key establishment, the integrity and confidentiality of user data traversing the network may be maintained at elevated security standards. In some implementations, the PQC IPSec connection may incorporate ephemeral keys that change frequently to minimize the risk of key exposure over time. The frequent change of keys may reduce a window of opportunity for potential attackers to intercept and decrypt a communication. Additionally, or alternatively, the base station 110 may enhance end-to-end protection by applying PQC models not only to the IPSec tunnel but also to the payload encryption within. This may ensure that an entire data packet, including the payload, benefits from the increased security provided by PQC models.

As shown at step 17, the UPF may optionally check if an application layer is protected using ML-KEM and/or ML-DSA. For example, the UPF may verify that application layer protocols are employing quantum-safe security measures. Ensuring application layer protection may further enhance the overarching security of the network by establishing comprehensive defenses from the user data to the application layer. In some implementations, the UPF may implement real-time threat detection mechanisms to monitor and ensure application layer security protocols are adhering to the latest PQC standards. These mechanisms may continuously analyze traffic for potential threats and automatically adjust security measures in response. Additionally, or alternatively, extending the PQC protection to application-level protocols may ensure that end-user applications benefit from the same level of security. This may guarantee that all implementations of the user application interactions are adequately protected against quantum threats.

In this way, high security quantum-safe network slices may be provided. For example, a network device may receive a secure identifier that is not quantum-safe from a UE 105 that is a subscriber to a quantum-safe network slice. The network device may prevent the UE 105 from accessing the quantum-safe network slice and may instruct the UE 105 to use a quantum-safe secure identifier. After receiving the quantum-safe secure identifier from the UE 105, the network device may register the UE 105 with the quantum-safe network slice and assign appropriate network functions to provide a requested service. The network device may reduce the risk of unauthorized access and the breadth of potential data breaches, which can be critical for maintaining the integrity and performance of 5G network infrastructure. Thus, the network device may conserve computing resources, networking resources, and/or other resources that would have otherwise been consumed by failing to provide secure communications for a UE 105 within a network, handling poor user experience and/or theft of data due to failing to provide secure communications for the UE 105 within the network, failing to authenticate the UE 105 with the network, and/or the like.

As indicated above, FIGS. 1A-1D are provided as an example. Other examples may differ from what is described with regard to FIGS. 1A-1D. The number and arrangement of devices shown in FIGS. 1A-1D are provided as an example. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

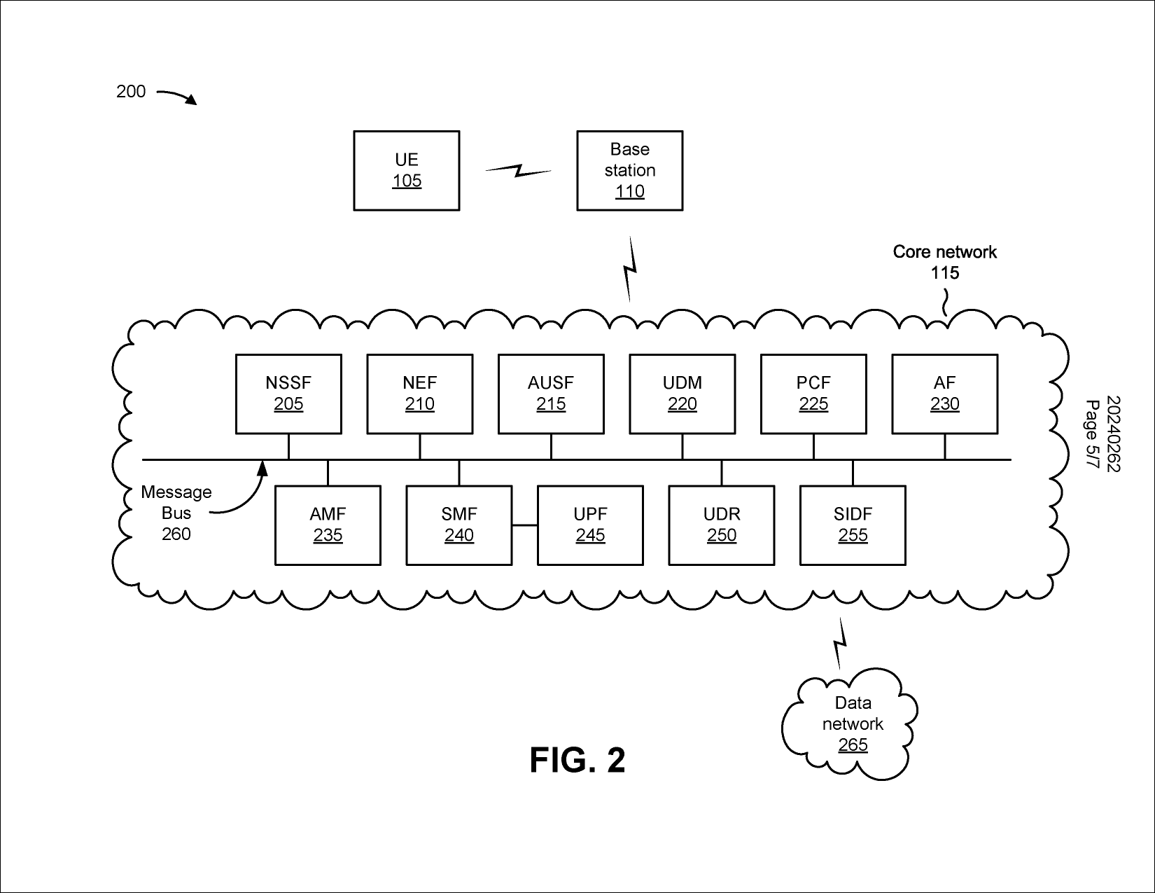

FIG. 2 is a diagram of an example environment 200 in which systems and/or methods described herein may be implemented. As shown in FIG. 2, the example environment 200 may include the UE 105, the base station 110, the core network 115, and a data network 265. Devices and/or networks of the example environment 200 may interconnect via wired connections, wireless connections, or a combination of wired and wireless connections.

The UE 105 includes one or more devices capable of receiving, generating, storing, processing, and/or providing information, such as information described herein. For example, the UE 105 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The base station 110 may support, for example, a cellular radio access technology (RAT). The base station 110 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The base station 110 may transfer traffic between the UE 105 (e.g., using a cellular RAT), one or more base stations (e.g., using a wireless interface or a backhaul interface, such as a wired backhaul interface), and/or the core network 115. The base station 110 may provide one or more cells that cover geographic areas.

In some implementations, the base station 110 may perform scheduling and/or resource management for the UE 105 covered by the base station 110 (e.g., the UE 105 covered by a cell provided by the base station 110). In some implementations, the base station 110 may be controlled or coordinated by a network controller, which may perform load balancing, network-level configuration, and/or other operations. The network controller may communicate with the base station 110 via a wireless or wireline backhaul. In some implementations, the base station 110 may include a network controller, a self-organizing network (SON) module or component, or a similar module or component. In other words, the base station 110 may perform network control, scheduling, and/or network management functions (e.g., for uplink, downlink, and/or sidelink communications of the UE 105 covered by the base station 110).

In some implementations, the core network 115 may include an example functional architecture in which systems and/or methods described herein may be implemented. For example, the core network 115 may include an example architecture of a fifth generation (5G) next generation (NG) core network included in a 5G wireless telecommunications system. While the example architecture of the core network 115 shown in FIG. 2 may be an example of a service-based architecture, in some implementations, the core network 115 may be implemented as a reference-point architecture and/or a 4G core network, among other examples.

As shown in FIG. 2, the core network 115 may include a number of functional elements. The functional elements may include, for example, a network slice selection function (NSSF) 205, a network exposure function (NEF) 210, an AUSF 215, a UDM component 220, a policy control function (PCF) 225, an application function (AF) 230, an AMF 235, an SMF 240, a UPF 245, a UDR 250, and/or an SIDF 255. These functional elements may be communicatively connected via a message bus 260. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice instances for the UE 105. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the UE 105 in the wireless telecommunications system.

The UDM 220 includes one or more devices that store user data and profiles in the wireless telecommunications system. The UDM 220 may be used for fixed access and/or mobile access in the core network 115.

The PCF 225 includes one or more devices that provide a policy framework that incorporates network slicing, roaming, packet processing, and/or mobility management, among other examples.

The AF 230 includes one or more devices that support application influence on traffic routing, access to the NEF 210, and/or policy control, among other examples.

The AMF 235 includes one or more devices that act as a termination point for non-access stratum (NAS) signaling and/or mobility management, among other examples. The AMF may establish and refresh security contexts between the UE 105 and the core network 115 to ensure that communication is secure and that data integrity and confidentiality are maintained. The AMF 235 may provide mutual authentication between the UE 105 and the core network 115. The AMF 235 may select and activate specific encryption and integrity protection models for user data and signaling.

The SMF 240 includes one or more devices that support the establishment, modification, and release of communication sessions in the wireless telecommunications system. For example, the SMF 240 may configure traffic steering policies at the UPF 245 and/or may enforce user equipment Internet protocol (IP) address allocation and policies, among other examples.

The UPF 245 includes one or more devices that serve as an anchor point for intraRAT and/or interRAT mobility. The UPF 245 may apply rules to packets, such as rules pertaining to packet routing, traffic reporting, and/or handling user plane QoS, among other examples.

The UDR 250 includes one or more devices that store and manage data relevant to subscribers and network functions, such as user subscription information, policy data, and session context. The UDR 250 acts as a unified and centralized database that various network functions can access. The UDM 220 may retrieve subscription data from the UDR 250 during user authentication, mobility, and access management procedures. The PCF 225 may refer to the UDR 250 to get policy rules when enforcing policies for data sessions. The SMF 240 may access the UDR 250 for session-related data to manage and maintain user sessions effectively.

The SIDF 255 includes one or more devices that enhance user identity protection. The SIDF 255 may de-conceal or decrypt a subscriber’s identity, which has been securely transmitted over the network, thereby protecting privacy and preventing unauthorized interception of sensitive information. The SIDF 255 may decrypt a SUCI received from the UE 105, and may convert the SUCI to a subscriber permanent identifier (SUPI). By encrypting the SUPI into SUCI at the UE 105, the SIDF 255 may ensures that the user’s permanent identity is protected during transmission. In the context of quantum-safe network slices, the SIDF 255 may utilize quantum-resistant encryption methods, making the core network 115 robust against future quantum computing threats.

The message bus 260 represents a communication structure for communication among the functional elements. In other words, the message bus 260 may permit communication between two or more functional elements.

The data network 265 includes one or more wired and/or wireless data networks. For example, the data network 265 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

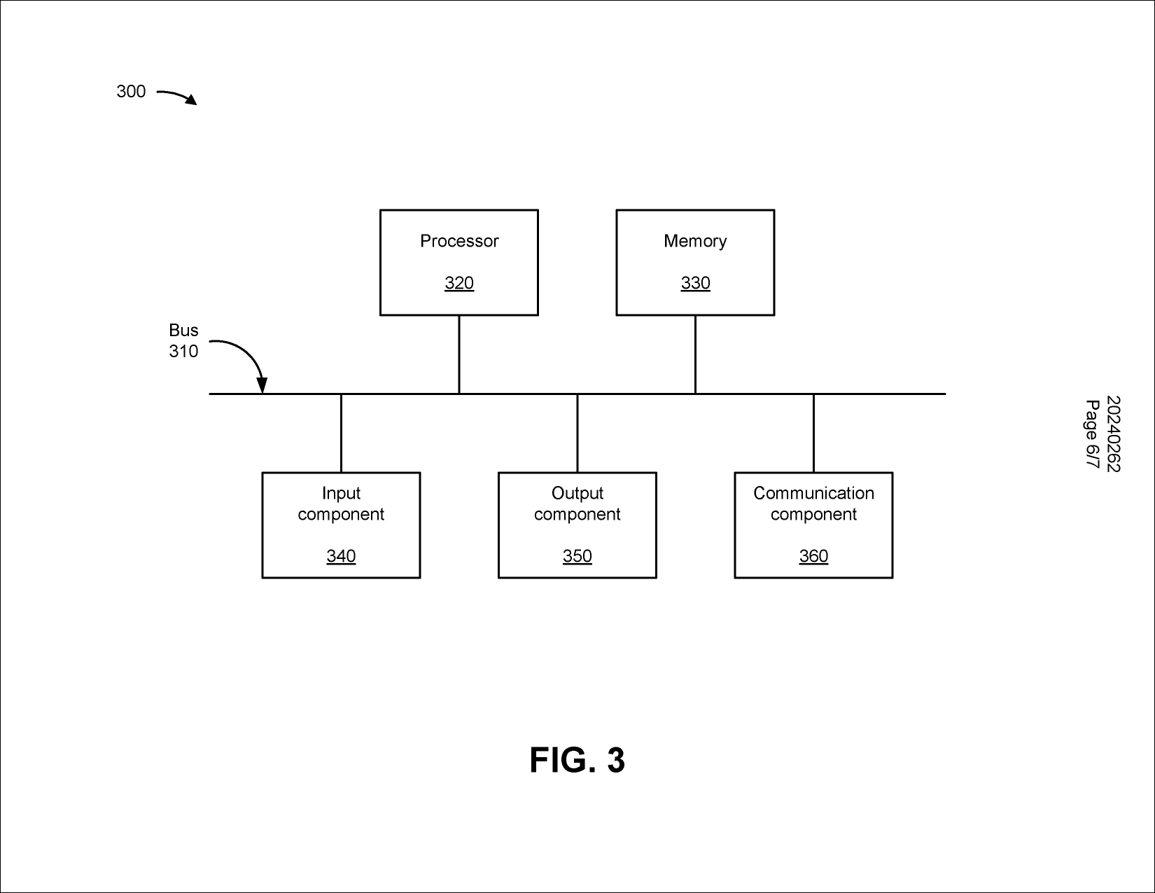

FIG. 3 is a diagram of example components of a device 300, which may correspond to the UE 105, the base station 110, the NSSF 205, the NEF 210, the AUSF 215, the UDM 220, the PCF 225, the AF 230, the AMF 235, the SMF 240, the UPF 245, the UDR 250, and/or the SIDF 255. In some implementations, the UE 105, the base station 110, the NSSF 205, the NEF 210, the AUSF 215, the UDM 220, the PCF 225, the AF 230, the AMF 235, the SMF 240, the UPF 245, the UDR 250, and/or the SIDF 255 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

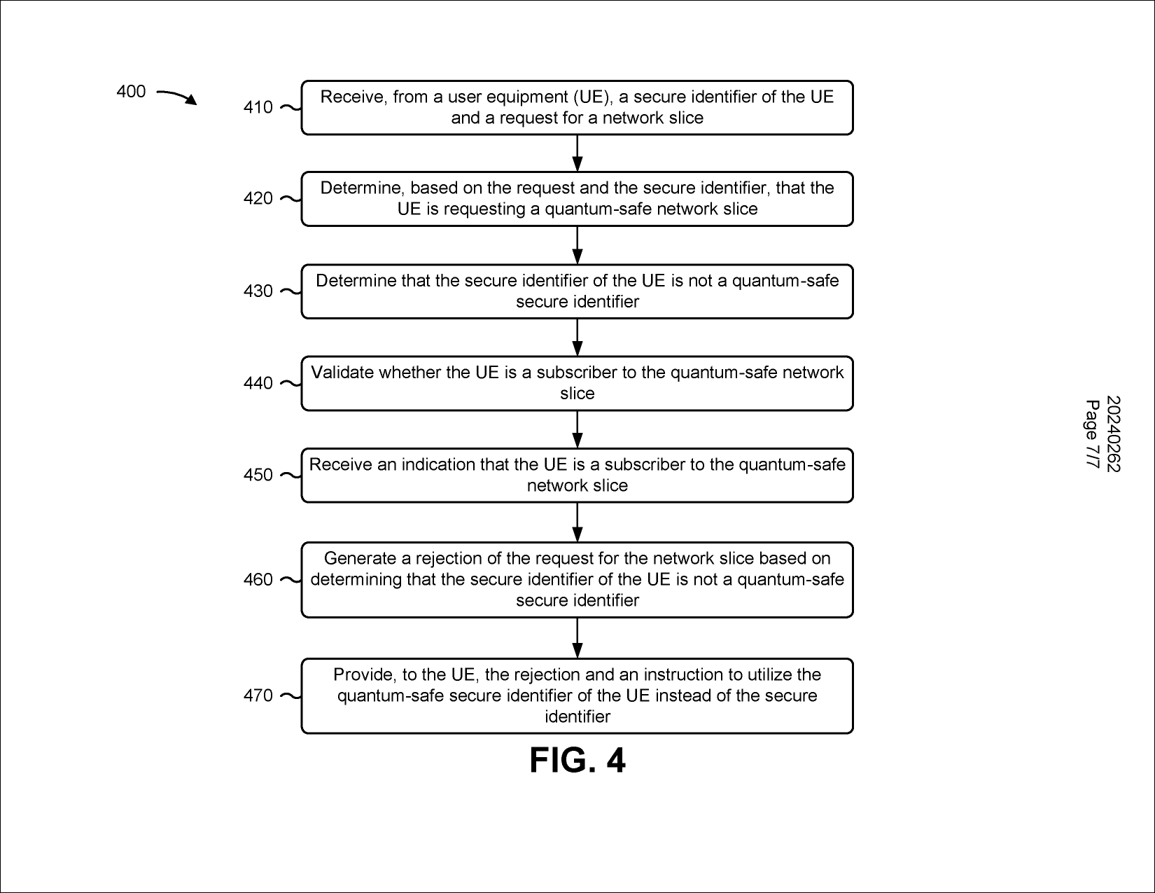

FIG. 4 is a flowchart of an example process 400 for providing high security quantum-safe network slices. In some implementations, one or more process blocks of FIG. 4 may be performed by a network device of the core network 115, such as the AMF 235. In some implementations, one or more process blocks of FIG. 4 may be performed by another device or a group of devices separate from or including the network device, such as another network device of the core network 115 (e.g., the AUSF 215, the UDM 220, the UPF 245, the UDR 250, and/or the SIDF 255). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving, from a UE, a secure identifier of the UE and a request for a network slice (block 410). For example, the network device may receive, from a UE, a secure identifier of the UE and a request for a network slice, as described above. In some implementations, receiving the request for the network slice includes receiving the request for the network slice via network slice selection assistance information indicating that the network slice is to be quantum safe. In some implementations, the network device is an AMF.

As further shown in FIG. 4, process 400 may include determining, based on the request and the secure identifier, that the UE is requesting a quantum-safe network slice (block 420). For example, the network device may determine, based on the request and the secure identifier, that the UE is requesting a quantum-safe network slice, as described above.

As further shown in FIG. 4, process 400 may include determining that the secure identifier of the UE is not a quantum-safe secure identifier (block 430). For example, the network device may determine that the secure identifier of the UE is not a quantum-safe secure identifier, as described above.

As further shown in FIG. 4, process 400 may include validating whether the UE is a subscriber to the quantum-safe network slice (block 440). For example, the network device may validate whether the UE is a subscriber to the quantum-safe network slice, as described above. In some implementations, validating whether the UE is a subscriber to the quantum-safe network slice includes accessing and verifying a subscriber profile of the UE to determine eligibility for the quantum-safe network slice.

As further shown in FIG. 4, process 400 may include receiving an indication that the UE is a subscriber to the quantum-safe network slice (block 450). For example, the network device may receive an indication that the UE is a subscriber to the quantum-safe network slice, as described above.

As further shown in FIG. 4, process 400 may include generating a rejection of the request for the network slice based on determining that the secure identifier of the UE is not a quantum-safe secure identifier (block 460). For example, the network device may generate a rejection of the request for the network slice based on determining that the secure identifier of the UE is not a quantum-safe secure identifier, as described above.

As further shown in FIG. 4, process 400 may include providing, to the UE, the rejection and an instruction to utilize the quantum-safe secure identifier of the UE instead of the secure identifier (block 470). For example, the network device may provide, to the UE, the rejection and an instruction to utilize the quantum-safe secure identifier of the UE instead of the secure identifier, as described above.

In some implementations, process 400 includes receiving, from the UE and after providing the rejection and the instruction, another request for the quantum-safe network slice and the quantum-safe secure identifier of the UE, registering the UE with the quantum-safe network slice based on the other request, and assigning one or more network functions to provide the quantum-safe network slice to the UE. In some implementations, process 400 includes establishing a quantum-safe interface with a base station serving the UE, instructing the base station to utilize a larger key size for RRC and UP protection, and providing, to the UE, a post-quantum cryptography model and the larger key size to be utilized by the UE for the quantum-safe network slice.

In some implementations, assigning the one or more network functions to provide the quantum-safe network slice to the UE includes identifying a base station and one or more network functions that support the quantum-safe network slice, and assigning the base station and the one or more network functions to provide the quantum-safe network slice to the UE. In some implementations, process 400 includes excluding one or more network functions from being assigned to provide the quantum-safe network slice to the UE, based on the one or more network functions not providing quantum-safe guarantees. In some implementations, process 400 includes establishing a quantum-resistant service based interface with a security mode command for provision of the quantum-safe network slice.

In some implementations, process 400 includes computing the quantum-safe secure identifier of the UE, and providing the quantum-safe secure identifier to the UE. In some implementations, computing the quantum-safe secure identifier of the UE includes utilizing a module-lattice-based key-encapsulation mechanism or a hybrid scheme to generate the quantum-safe secure identifier of the UE.

In some implementations, process 400 includes receiving a change to requirements for the quantum-safe network slice, and modifying the quantum-safe secure identifier based on the change. In some implementations, process 400 includes monitoring a status of the quantum-safe network slice and the quantum-safe secure identifier, and reporting the status to a subscriber management function.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a network device and from a user equipment (UE), a secure identifier of the UE and a request for a network slice;
determining, by the network device and based on the request and the secure identifier, that the UE is requesting a quantum-safe network slice;
determining, by the network device, that the secure identifier of the UE is not a quantum-safe secure identifier;
validating, by the network device, whether the UE is a subscriber to the quantum-safe network slice;
receiving, by the network device, an indication that the UE is a subscriber to the quantum-safe network slice;
generating, by the network device, a rejection of the request for the network slice based on determining that the secure identifier of the UE is not a quantum-safe secure identifier; and
providing, by the network device and to the UE, the rejection and an instruction to utilize the quantum-safe secure identifier of the UE instead of the secure identifier.

2. The method of claim 1, further comprising:
receiving, from the UE and after providing the rejection and the instruction, another request for the quantum-safe network slice and the quantum-safe secure identifier of the UE;
registering the UE with the quantum-safe network slice based on the other request; and
assigning one or more network functions to provide the quantum-safe network slice to the UE.

3. The method of claim 2, further comprising:
establishing a quantum-safe interface with a base station serving the UE;
instructing the base station to utilize a larger key size for radio resource control (RRC) and user plane (UP) protection; and
providing, to the UE, a post-quantum cryptography model and the larger key size to be utilized by the UE for the quantum-safe network slice.

4. The method of claim 2, wherein assigning the one or more network functions to provide the quantum-safe network slice to the UE comprises:
identifying a base station and one or more network functions that support the quantum-safe network slice; and
assigning the base station and the one or more network functions to provide the quantum-safe network slice to the UE.

5. The method of claim 2, further comprising:
excluding one or more network functions from being assigned to provide the quantum-safe network slice to the UE, based on the one or more network functions not providing quantum-safe guarantees.

6. The method of claim 2, further comprising:
establishing a quantum-resistant service based interface with a security mode command for provision of the quantum-safe network slice.

7. The method of claim 1, wherein receiving the request for the network slice comprises:
receiving the request for the network slice via network slice selection assistance information indicating that the network slice is to be quantum safe.

8. A network device, comprising:
one or more memories; and
one or more processors, coupled to the one or more memories, configured to:
receive, from a user equipment (UE), a secure identifier of the UE and a request for a network slice;
determine, based on the request and the secure identifier, that the UE is requesting a quantum-safe network slice;
determine that the secure identifier of the UE is not a quantum-safe secure identifier;
validate whether the UE is a subscriber to the quantum-safe network slice;
receive an indication that the UE is a subscriber to the quantum-safe network slice;
generate a rejection of the request for the network slice based on determining that the secure identifier of the UE is not a quantum-safe secure identifier;
provide, to the UE, the rejection and an instruction to utilize the quantum-safe secure identifier of the UE instead of the secure identifier;
receive, from the UE and after providing the rejection and the instruction, another request for the quantum-safe network slice and the quantum-safe secure identifier of the UE; and
register the UE with the quantum-safe network slice based on the other request.

9. The network device of claim 8, wherein the network device is an access and mobility management function.

10. The network device of claim 8, wherein the one or more processors, to validate whether the UE is a subscriber to the quantum-safe network slice, are configured to:
access and verify a subscriber profile of the UE to determine eligibility for the quantum-safe network slice.

11. The network device of claim 8, wherein the one or more processors are further configured to:
compute the quantum-safe secure identifier of the UE; and
provide the quantum-safe secure identifier to the UE.

12. The network device of claim 11, wherein the one or more processors, to compute the quantum-safe secure identifier of the UE, are configured to:
utilize a module-lattice-based key-encapsulation mechanism or a hybrid scheme to generate the quantum-safe secure identifier of the UE.

13. The network device of claim 8, wherein the one or more processors are further configured to:
receive a change to requirements for the quantum-safe network slice; and
modify the quantum-safe secure identifier based on the change.

14. The network device of claim 8, wherein the one or more processors are further configured to:
monitor a status of the quantum-safe network slice and the quantum-safe secure identifier; and
report the status to a subscriber management function.

15. A non-transitory computer-readable medium storing a set of instructions, the set of instructions comprising:
one or more instructions that, when executed by one or more processors of a network device, cause the network device to:
receive, from a user equipment (UE), a secure identifier of the UE and a request for a network slice,
wherein the network device is an access and mobility management function;
determine, based on the request and the secure identifier, that the UE is requesting a quantum-safe network slice;
determine that the secure identifier of the UE is not a quantum-safe secure identifier;
validate whether the UE is a subscriber to the quantum-safe network slice;
receive an indication that the UE is a subscriber to the quantum-safe network slice;
generate a rejection of the request for the network slice based on determining that the secure identifier of the UE is not a quantum-safe secure identifier; and
provide, to the UE, the rejection and an instruction to utilize the quantum-safe secure identifier of the UE instead of the secure identifier.

16. The non-transitory computer-readable medium of claim 15, wherein the one or more instructions further cause the network device to:
receive, from the UE and after providing the rejection and the instruction, another request for the quantum-safe network slice and the quantum-safe secure identifier of the UE;
register the UE with the quantum-safe network slice based on the other request;
assign one or more network functions to provide the quantum-safe network slice to the UE;
excluding one or more network functions from being assigned to provide the quantum-safe network slice to the UE, based on the one or more network functions not providing quantum-safe guarantees;
establish a quantum-safe interface with a base station serving the UE;
instruct the base station to utilize a larger key size for radio resource control (RRC) and user plane (UP) protection; and
provide, to the UE, a post-quantum cryptography model and the larger key size to be utilized by the UE for the quantum-safe network slice.

17. The non-transitory computer-readable medium of claim 16, wherein the one or more instructions further cause the network device to:
establish a quantum-resistant service based interface with a security mode command for provision of the quantum-safe network slice.

18. The non-transitory computer-readable medium of claim 15, wherein the one or more instructions, that cause the network device to receive the request for the network slice, cause the network device to:
receive the request for the network slice via network slice selection assistance information indicating that the network slice is to be quantum safe.

19. The non-transitory computer-readable medium of claim 15, wherein the one or more instructions, that cause the network device to validate whether the UE is a subscriber to the quantum-safe network slice, cause the network device to:
access and verify a subscriber profile of the UE to determine eligibility for the quantum-safe network slice.

20. The non-transitory computer-readable medium of claim 15, wherein the one or more instructions further cause the network device to:
compute the quantum-safe secure identifier of the UE; and
provide the quantum-safe secure identifier to the UE.
